(19) United States
(12) Patent Application Publication
(10) Pub. No.: US 2007/0215576 A1
(43) Pub. Date: Sep. 20, 2007

(54) Electric shock prevention residual current circuit breaker

(75) Inventor: Yuecheung Chung, Guangzhou (CN)

Correspondence Address: Ruay L. Ho;Suite 400, 1700 Pennsylvania Ave., NW, Washington, DC, 20006, US

(73) Assignee: South China Engineering & Manufactured LTD.

(21) Appl. No.: 11/785,766

(22) Filed: Apr. 19, 2007

(30) Foreign Application Priority Data
Oct. 21, 2004 (CN) PCT/CN05/01340

(51) Int. Cl. H01H 33/16

(52) U.S. Cl. 218/143

(57) ABSTRACT

An electric shock prevention residual current circuit breaker provides electrical shock protection before contact of any current. The circuit breaker eliminating the flaws of the concurrent residual current circuit breakers comprises a digital logic microcontroller, a fault sensor circuit, an electromagnetic trip circuit, a low voltage supply circuit, a ground line circuit, and a set of corresponding members, such as a close or open circuit assembly, an input terminal, an output terminal, a switch handle, an overcurrent and short circuit trip device, a dynamic contact, a static contact, an avoiding arc device, a leakage detecting circuit, and a housing unit.

### FIELD OF THE INVENTION

The present invention relates generally to an electric shock prevention residual current circuit breaker. More particularly, the present invention relates to a no-current-contact electric shock prevention residual current circuit breaker that is controlled by a digital logic microcontroller and can protect against current leakage, overcurrent and short circuit. In addition, this no-current-contact electric shock prevention residual current circuit breaker is designed to provide new, intelligent protection and protection in advance of actual contact with an electric current, against electrical accidents such as electric shock and electrical fire that may likely lead to bodily injuries and fatalities, and that are caused by disconnected ground lines (due to loose or broken connections) under a controlled circuit, and by a hot ground line or a hot neutral line, a neutral line misconnected with the phase lines, a single phase misconnected with the two phases, and over voltage, and it can essentially eliminate indirect electric shocks to persons and electrical fires.

### BACKGROUND OF THE INVENTION

In comparison with similar models of current residual current circuit breakers in the world, the present invention consumes less power, has a slightly higher manufacturing cost, but is no larger in size.

The current residual current circuit breaker was put into use half a century ago, and it has been brought into the high-tech era through continuous improvement in its structure and breaking capacity. However, its main functions are still imperfect and its flaws include that it is not able to provide protection from a variety of electric shocks that can likely occur to a person from electrical accidents caused by disconnected ground lines (due to loose or broken connections) in a controlled circuit, and by hot ground line or hot neutral line, misconnected neutral lines with the phase lines, misconnected single phase with the two phases, and over-voltage, nor can it provide protection in advance against electric shocks without contacting electric current.

Protection provided against electric shocks only after contact with an electric current is an incomplete protection because the person is surely to suffer some level of injury, whether it is minor or severe.

Protection against electric shocks without contact with an electric current is an improved protection. Since no electric current passes through the body, no bodily harm is done to the person. Complete protection is certainly an improvement over incomplete protection.

The key to the present invention's intelligent protection against electric shock without contact with an electric current is the digital logic microcontroller that is original to this invention. It consumes little power, is small in size, is easy to install, and is inexpensive to produce. Therefore, compared with similar models of the current residual current circuit breakers in the world, the present invention consumes less power, is no bigger in size and has only a slightly higher manufacturing cost.

The intelligent protection against electric shock without contact with an electric current, that can be caused by various electrical faults such as disconnected ground lines (due to loose or broken connections) in a controlled circuit, hot ground line or hot neutral line, misconnected neutral lines with the phase lines, misconnected single phase with the two phases, and over-voltage (these types of electric faults are referred to hereafter when necessary, as the electric faults caused by “disconnected ground lines, etc.”), in a controlled circuit, is a very reliable measure for electrical safety.

The intelligent protection against electric shock without contact with an electric current, that can be caused by various electrical faults such as disconnected ground lines (due to loose or broken connections) in a controlled circuit, hot ground line or hot neutral line, misconnected neutral lines with the phase lines, misconnected single phase with the two phases, and over-voltage (these types of electric faults are referred to hereafter when necessary, as the electric faults caused by “disconnected ground lines, etc.”), in a controlled circuit, is a very reliable measure for electrical safety.

This is because even if a residual current circuit breaker (of the type currently used around the world) is installed, it can not replace the protection provided by a properly connected ground line. Without the protection of the properly connected ground lines, the circuit breaker only provides protection after contact with an electric current, or it may not provide any protection even after an electric shock. Either scenario is unsafe.

Providing protection only after contact with an electric current will cause bodily harm. Contact with a 30 mA electric current is not safe. Depending on the environment (e.g. a wet environment or an environment that is likely to lead to secondary injuries) an electric current of as little as 10-25 mA can lead to minor, sever or even fatal injuries depending on the whether the person is young, a fit adult, old, a child, pregnant, sick or disabled. This is because at the moment of contact with an electrical current and experiencing an electric shock, most people panic. If the victim(s) can not help themselves away from contact with the electric current, and if the leakage current has not reached the set range, the residual current circuit breaker cannot provide open circuit protection. Thus, the electrical current continues to flow through the body and causes a fatal electrocution.

According to data analysis conducted by the relevant institutions in America, Japan and China, most electric shock fatalities and electrical fire accidents are the result of disconnected ground lines (due to loose or broken connections), hot ground lines or hot neutral lines, misconnected neutral lines with the phase lines, misconnected single phase with the two phases, and over-voltage. These electrical accidents are the protection “blind spots” of the residual current circuit breakers currently in use today, which do not provide protection or provide protection only after contact with an electric current and an electric shock. That is why the developed countries such as America and Japan began to use current operational type residual current circuit breaker in the 1960s. However, there are still numerous electric shock fatalities and electrical fire accidents that occur each year.

While grounding protection is essential, the current technology can not guarantee the effectiveness of the protection devices via connecting ground lines.

Therefore, only by designing an electric shock prevention residual current circuit breaker that can provide intelligent protection against the electrical faults caused by the “disconnected ground line, etc.,” can we ensure effectiveness of grounding protection in a controlled circuit. Such a design would greatly contribute to global electrical safety, the prevention of electric shock fatalities and injuries, and electrical fires.

### SUMMARY

The main object of the present invention is to provide a no-current-contact electric shock prevention residual current circuit breaker that is controlled by a digital logic microcontroller, that in addition to providing current leakage protection, overcurrent protection, and short circuit protection, it provides an intelligent protection against electric shocks without contact with an electric current, caused by various electrical faults such as disconnected ground lines (due to loose or broken connections),a hot ground line or hot neutral line, misconnected neutral lines with the phase lines, misconnected single phase with the two phases, and over-voltage. It can also provide protection in advance that can virtually eliminate indirect electric shocks and fires.

Another object of the present invention is to design a no-current-contact electric shock prevention residual current circuit breaker that provides a new intelligent protection that can provide protection before contact with an electric current, and can provide protection in advance, thus eliminating the flaws of the residual current circuit breakers in use in the world today. These flaws include providing protection only after contact with an electric current and suffering an electric shock, or unable to provide protection against electrical accidents caused by “disconnected ground lines, etc.” in a controlled circuit system.

Yet another object is to provide a new generation of no-current-contact electric shock prevention residual current circuit breaker that consume less power, are no larger in size and cost only slightly more than the residual current circuit breakers currently in use in the world.

### TECHNICAL SCHEME OF THE INVENTION

The present invention comprises mainly: a digital logic microcontroller A, fault sensor circuit B, electromagnetic trip circuit C, low voltage supply circuit D, ground line circuit PE, and a set of corresponding members F, and others.

Among Which:

1. Digital logic microcontroller A includes first tier circuit a1; second tier circuit a2; logic processing circuit a3; precursor circuit a4; and digital generating circuit a5.

2. Fault sensor circuit B includes leakage sensor circuit b1; sensor circuit b2 of “disconnected ground line, etc.”

3. The electromagnetic trip circuit C includes rear driving circuit c1; and electromagnetic trip device c2.

4. Low voltage supply circuit D includes voltage reducing capacitor C1, filter capacitor C2, diode D1, diode D2 and voltage-regulator tube Dz.

5. The ground line circuit PE includes a metal plate PE terminal at the bottom of the housing; and connecting wires.

6. A set of corresponding members F includes close or open circuit assembly F1; the input terminal F2; output terminal F3; switch handle F4; overcurrent and short circuit trip device F5; dynamic contact F6; static contact F7; avoiding arc device F8; leakage experimental circuit F9; and housing F10.

The operating principle and diagrams of sectional circuits and their connections in the present invention are described below in the preferred embodiments of practice of the invention.

### BRIEF DESCRIPTION OF THE DRAWINGS

FIG. 1 illustrates a sectional side view of the present invention;

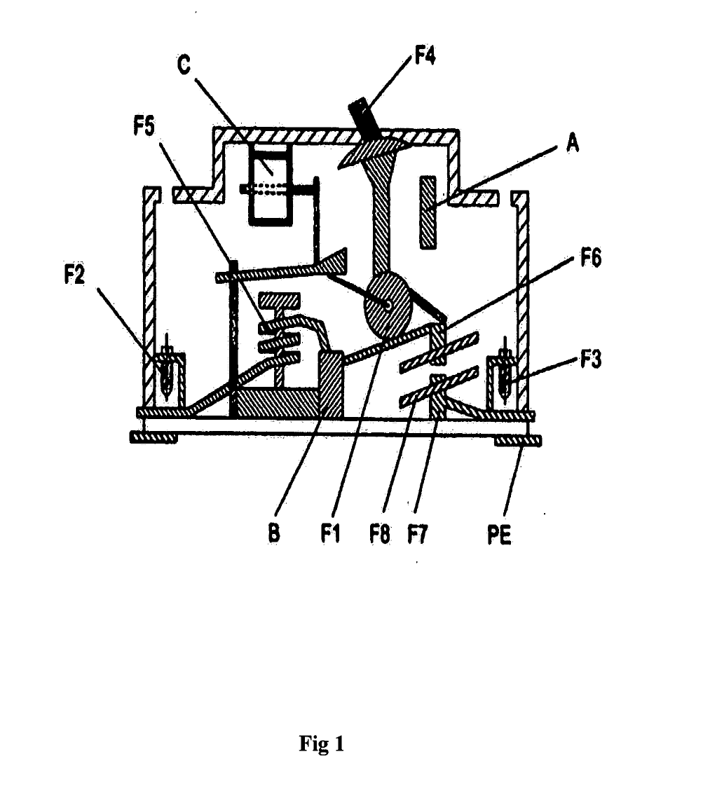

FIG. 2 illustrates an electrical schematic diagram showing the present invention;

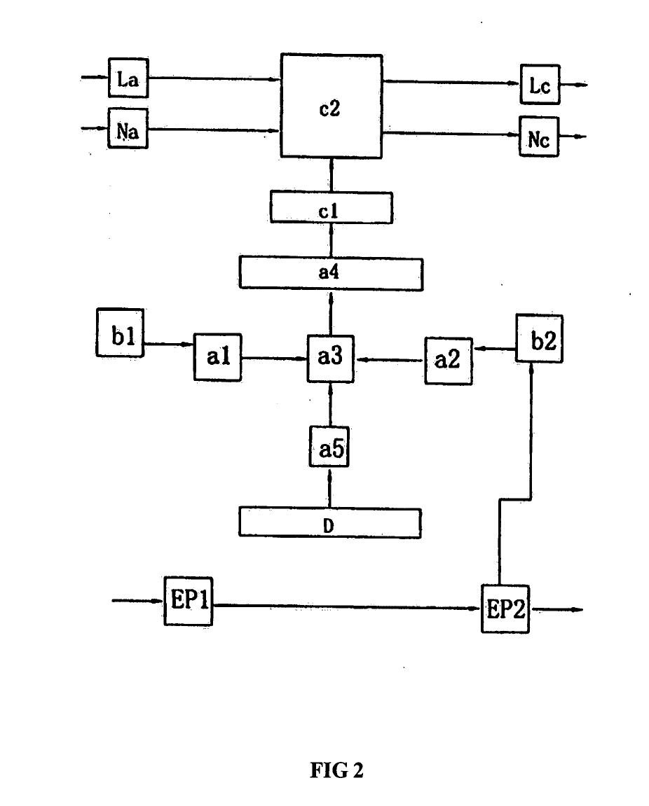

FIG. 3 illustrates a schematic diagram showing the internal structure of digital logic microcontroller A of the present invention;

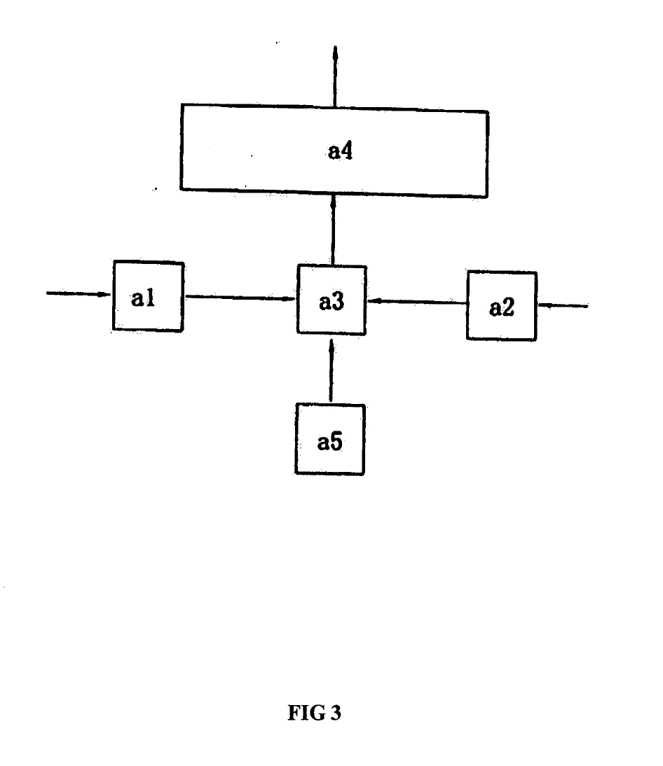

FIG. 4 illustrates an electrical schematic diagram of the first preferred embodiment of the present invention;

FIG. 5 illustrates an electrical schematic diagram of the second preferred embodiment of the present invention;

FIG. 6 illustrates an electrical schematic diagram of the third preferred embodiment of the present invention; and

FIG. 7 illustrates an electrical schematic diagram of the fourth preferred embodiment of the present invention.

### DETAILED DESCRIPTION OF THE INVENTION

Preferred Embodiment 1

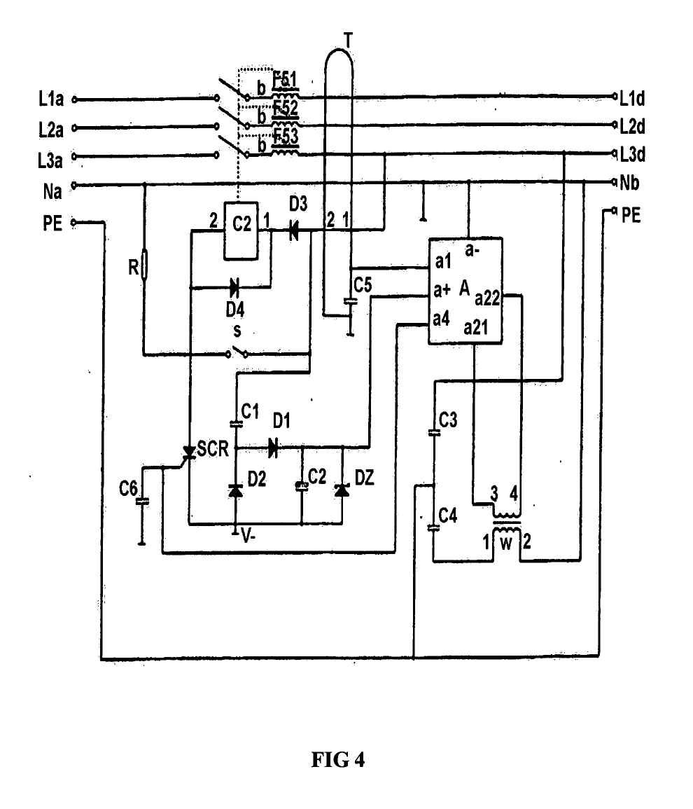

The preferred embodiment is a three-phase electronic no-current-contact electric shock prevention residual current circuit breaker (five lines: L1+L2+L3+N+PE) and its electrical schematic diagram is shown in FIG. 4.

The preferred embodiment comprises digital logic microcontroller A, fault sensor circuit B, electromagnetic trip circuit C, low voltage supply C, low voltage supply circuit D, ground line circuit PE, and a set of corresponding members F.

The circuit components and connections of the present preferred embodiment are as follows:

1. low voltage supply circuit D comprised voltage reducing capacitor C1, filter capacitor C2, diode D1, diode D2, voltage-regulator tube Dz, in which one end of C1 is connected to the phase line L3d, the other end of C1 is parallel connected with the anode of D1 and the cathode of D2; the cathode of D1 and the anode of C2, and the cathode of Dz are parallel connected to become low-voltage power supply V+; the anode of D2, the cathode of C2, and the anode of Dz are parallel connected to become low-voltage power supply V−; V+ is connected to a+ of digital logic microcontroller A, and V− is connected with a− of A; V− is also a shared “−”electrode which is in turn connected with neutral line Nb.

2. Leakage sensor circuit b1 in fault sensor circuit B comprises zero-sequence current transformer T and capacitor c5, in which the three-phase lines L1b, L2b, L3b and neutral line Nb go through the middle hole of T electromagnetic winding, the winding end 1 of T is connected with input terminal al, T winding end 2 is connected to the shared “−” electrode, one end of C5 is connected with T winding end 1 and the other end is connected to T winding end 2.

3. Leakage sensor circuit b2 for disconnected ground lines, etc. in fault sensor circuit B comprises coupler w, capacitor C3 and capacitor C4, and in which one end of C3 is connected with output Ld of the power source phase lines, the other end of C3 is first parallel connected with C4 and then connected with end 1 of w, and end 2 of w is connected with Nd of the power supply neutral lines, and the end 3 of w is connected with the input end a21 of the second tier circuit a2 and end 4 of w is connected with input end a22.

Rear driving circuit c1 comprises thyristor SCR and capacitor C6, in which SCR anode is connected with end 1 of c2, SCR cathode is connected with the shared “−” electrode, and SCR control gate is connected with the output of precursor circuit a4, one end of C6 is connected with SCR control gate and the other end of C6 is connected with the shared “−” electrode.

5. Electromagnetic trip device c2 includes diode D3 and follow-current diode D4, and in which, end 2 of c2 is connected with the cathode of D3, the anode of D3 is connected with the L3d of the phase lines, end 1 of c2 is connected to SCR anode, the cathode D4 is connected with end 2 of c2, and the anode of D4 is connected with end 1 of c2.

6. Overcurrent and short circuit trip device F5 comprises F51, F52 and F53, and in which one end of F51 is connected with L1b of the phase lines, the other end of the F51 is connected with L1c of the phase lines, one end of F52 is connected with L2b of the phase lines, and the other end of F52 is connected to L2c of the phase lines, one end of F53 is connected with L3b of F53 and the other end of F53 is connected to L3c of the phase lines.

One end of ground line PE is led out from the junction of C3 and C4 of sensor circuit b2 for disconnected ground lines, etc., the other end is connected with metal plate PE terminal at the bottom of the housing. When first in use, the input of PE is fixed to the ground line PEN under the “TN−C−S” electricity supply system, or is fixed to the grounded ground line under the “T−T” electricity supply system, or is fixed to the qualified ground lines that are repeatedly grounded, and the output is fixed to the metal housing or the metal frame of a controlled electric equipment.

8. Leakage testing circuit F9 comprises resistor R, leakage testing switch S, and in which one end of R is connected with L3b of the phase lines and the other end is connected to one end of the switch S, and the other end of switch S is connected with Nb of the neutral line.

9. The input terminals F21, F22, F23 and F24 are respectively connected with L1a of the phase line, L2a of the phase line, and Na of the neutral line.

The output terminals F31, F32, F33, and F34 are respectively connected with L1d of the phase line, L2d of the phase line and Nb of the neutral line.

Operating Principle of the Preferred Embodiment 1

When in use, first pull the switch handle F4 to the “on” position. If there is no current leakage such as a loop current leakage, or electrical faults caused by the “disconnected ground line, etc.” in a controlled circuit at the time, dynamic contact F6 is pressed tightly to connect static contact F7 to allow the power supply line to transmit electricity normally in the controlled circuit.

Example 1-1, when a loop current leakage in a controlled circuit occurs, the device trips and disconnects via zero-sequence current transformer T which comprises of leakage sensor circuit b1, and from b1 to first tier circuit al, to logic processing circuits a3, to precursor circuit a4, rear driving circuit c1, and finally to electromagnetic trip device c2. This entire operation takes less than 0.1 seconds. Thus, within 0.1 seconds of when an electric fault occurs, the device can automatically eliminate in advance current leakage accidents that may cause bodily injury or death by electric shock.

Example 1-2, in the case of electric faults caused by a disconnected ground line in a controlled circuit: Under normal conditions, there is no electric potential difference or very little difference between ground line PE and neutral line N, and between the “earth,” when the ground line PE is connected with ground line PEN under the “TN_31 C−S” electricity supply system, or it is connected with a ground line under the “T−T” electricity supply system, or is connected with the qualified ground line that is repeatedly grounded. When the electric faults caused by a disconnected ground line occur, the ground line is suspended, which leads to the high electric voltage in coupler w of sensor circuit b2 of the disconnected ground line and others. This high electric voltage couples to second tier circuit a2, to logic processing circuits a3, then to precursor circuit a4, to rear driving circuit c1, and finally to electromagnetic trip device c2, and it sets off the device to trip and disconnect. The entire operation takes 0.2 to 1 second. This time is adjustable. Thus, within 0.2 to 1 second of when an electric fault occurs, the device can automatically eliminate in advance the electric accidents resulting from the disconnected ground line that may cause bodily injury or death by electric shock.

Example 1-3, in case of electric faults caused by a disconnected ground line in a controlled circuit: Under normal conditions, there is no electric potential difference or very little difference between ground line PE and neutral line N, and between “earth.” However, when repeated short circuits occur between the phase lines and the neutral lines (under the TN electricity supply system), or when relatively large electric leakage occurs in other electric circuits, electric faults occur (it is quite dangerous because the housing of the electric equipment becomes hot under the TN electricity supply system). There is a high electric voltage between the ground lines PE, neutral line N and “earth” when an electric fault occurs due to a hot ground line. This high voltage also leads to a high electric voltage in coupler w of sensor circuit b2 of the disconnected ground line and others. The high electric voltage couples to second tier circuit a2, to logic processing circuit a3, then to precursor circuit a4, to rear driving circuit c1, and finally to electromagnetic trip device c2 which trips and disconnect. The entire operation completes within 0.2 to 1 second and the time can be adjusted. Thus, within 0.2 to 1 second of when an electric fault occurs, the device can automatically eliminate in advance the electric accidents resulting from a hot ground line that may cause bodily injury or death by electric shock.

Example 1-4, In case of electric faults caused by a hot neutral line: Under normal conditions, there is no electric potential difference or very little difference between the neutral line N and the ground line PE, and between “earth.” However, a hot neutral line electric fault can occur if the neutral line is misconnected with the phase lines, or one phase is missing from three phases. Such faults lead to an electric potential difference between the neutral line N, the ground line PE and “earth”, which can cause bodily injury and death by electric shock (it is quite dangerous because the housing of the electric equipment becomes hot under the TN electric system).

This high voltage also leads to a high electric voltage in the coupler w of the sensor circuit b2 of the disconnected ground line, etc. The high electric voltage couples to the second tier circuit a2, to the logic processing circuit a3, then to the precursor circuit a4, to the rear driving circuit c1, and finally to the electromagnetic trip device c2 which trips and disconnect. The entire operation completes within 0.2 to 1 second and the time can be adjusted. Thus, within 0.2 to 1 second of when an electric fault occurs, the device can automatically eliminate in advance the electric accidents resulting from a hot neutral line that may cause bodily injury or death by electric shock.

Example 1-5, in the case of faults caused by a misconnect of the neutral line with the phase lines in a controlled circuit; it operates similarly as in the case of hot neutral line faults. Within 0.2 to 1 second of when an electric fault occurs, the device also can automatically eliminate in advance the electric accidents resulting from a hot neutral line that may cause bodily injury or death by electric shock.

Example 1-6, in the case of faults caused by a single phase misconnect with the two phases under a controlled circuit, it operates similarly as in the case of hot neutral line faults. Such electrical faults generate nearly twice as much overvoltage which can very likely bum up controlled electrical equipment and cause fire within a few seconds. Within 0.2 to 1 second of when such electric faults occur, the present invention can automatically eliminate in advance the severe electric accidents that may cause bodily injury or deaths by electric shock and electrical fires.

Example 1-7, in the case of electric faults caused by the overcurrent of the single-phase, two-phase or three-phase, and short circuit etc, related trip devices F51, F52 and F53 and others generate relatively strong electromagnetic attracting (repelling) force to provide protection by tripping and disconnecting the electrical system.

Preferred Embodiment 2

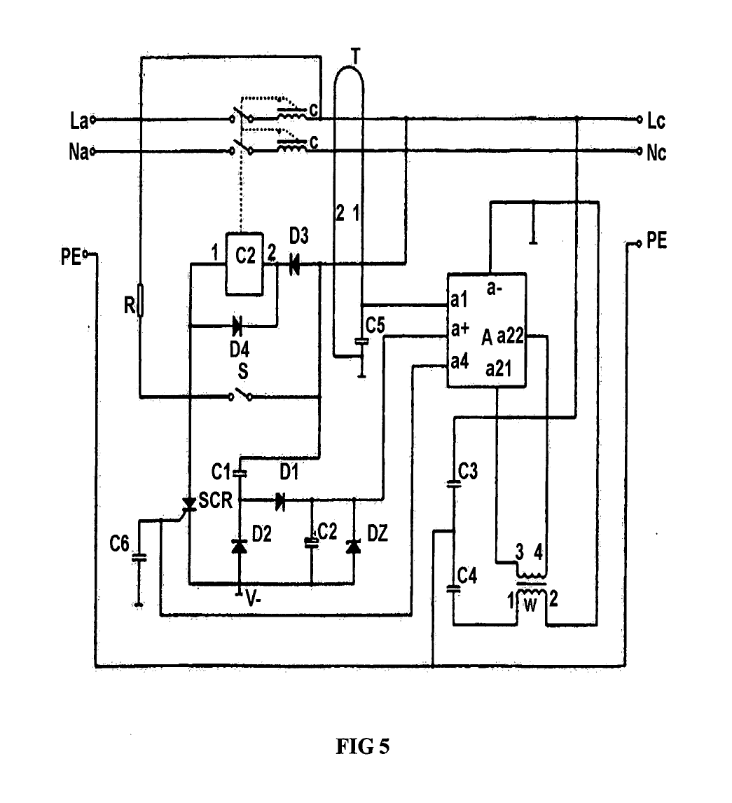

The present preferred embodiment is a single-phase electronic no-current-contact electric shock prevention residual current circuit breaker (three lines: L+N+PE). Its electrical schematic diagram is shown in FIG. 5.

The device of the present preferred embodiment comprises the following components: digital logic microcontroller A, fault sensor circuit B, electromagnetic trip circuit C, low voltage supply circuit B, ground line circuit PE and a set of corresponding members F and others.

The electric circuit diagram of the present preferred embodiment and its connections are as follows:

1. Low voltage supply circuit D comprises voltage reducing capacitor C1, filter capacitor C2, diode D1, diode D2, voltage-regulator tube Dz; in which, one end of C1 is connected with phase lines Ld and the other end is parallel connected with the anode of D1 and the cathode of D2; the cathode of D1, the anode of C2 and the cathode of Dz are parallel connected to become low-voltage power supply V+; the anode of D2, the cathode of C2, and the anode of Dz are parallel connected to become the low-voltage power supply V−; V+ is connected with a+ of digital logic microcontroller A, and V− is connected with a− of A; V− is the shared “−”electrode and it is then connected with neutral line Nd.

2. Leakage sensor circuit b1 in fault sensor circuit B comprises zero-sequence current transformer T, capacitor c5, and others; in which, phase line Lc and neutral line Nc go through the middle hole of T electromagnetic winding, T winding end 1 is connected with input terminal a1 of first tier circuit, T winding end 2 is connected to the shared “−” electrode, and one end of C5 is connected with T winding end 1 and the other end of C5 is connected to T winding end 2.

3. Sensor circuit b2 of the disconnected ground line in fault sensor circuit B comprises coupler w, capacitor C3 and capacitor C4 and others; in which, one end of C3 is connected with power supply output end Ld, the other end of C3 is then connected to end 1 of w, end 2 of w is connected to power supply neutral line Nd, end 3 of w is connected to input end a21 of second tier circuit a2, and end 4 of w is connected to input a22.

4. Rear driving circuit c1 comprises tryristor SCR, capacitor C6 and others; in which the anode of SCR is connected with end 1 of c2, the cathode of SCR is connected to the shared “−” electrode, and the control gate of SCR is connected with output a4 of the precursor circuit, one end of C6 is connected with the control gate of SCR and the other end of C6 is connected with the shared “−” electrode.

5. Electromagnetic trip device c2 includes diode D3, follow-current diode D4; in which end 2 of c2 is connected to the cathode of D3, the anode of D3 is connected with Ld end of the phase line, the cathode of D4 is connected with end 2 of c2 and the anode of D4 is connected with end 1 of c2.

6. Overcurrent and short circuit trip device F5 includes F51 and F52; in which, one end of F51 is connected with L1b end of the phase line and the other end of F51 is connected with L1c of the phase line, and one end of F52 is connected to Nb end of the neutral line and the other end of F52 is connected with Nc end of the neutral line.

7. One end of ground line PE is led out from the junction of C3 and C4 in sensor circuit b2 of the disconnected ground line, the other end of PE is connected with the metal plate PE terminal at the bottom of the housing. When first in use, the input end of PE is fixed to ground line PEN under the “TN−C−S” electricity supply system, or is fixed to the grounded ground line under the “T−T” electricity supply system, or is fixed to qualified ground line that is repeatedly grounded, and the output end is fixed to the metal housing or metal frame of the controlled electric equipment.

8. Leakage testing circuit F9 comprises resistor R, leakage testing switch S and other; in which, one end of R is connected to Lc end of the phase line and the other end of R is connected with one end of switch S, and the other end of switch S is connected to Nd of the neutral line.

9. Input terminals F21 and F22 are connected with La of the phase lines and Na of the neutral line respectively.

10. Output terminals F31 and F32 are parallel connected to Ld of the phase line and Nd of the neutral line.

The operating principle of the preferred embodiment 2 is similar to that of the preferred embodiment 1, therefore it is not described here.

Preferred Embodiment 3

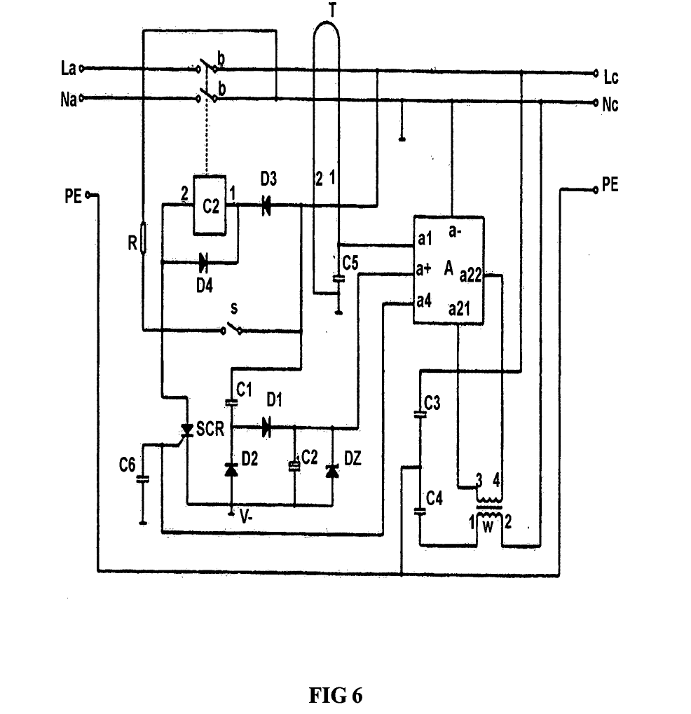

The preferred embodiment is a single-phase electronic leakage current protection device without an electric current contact (three lines: L+N+PE). Its electrical schematic diagram is shown in FIG. 6.

The current technology uses the term “residual current circuit breaker” for devices that provide protection against overcurrent and short circuit. Devices that do not have protective functions against overcurrent and short circuit are termed current leakage protection device.

The preferred embodiment does not concurrently provide protection against overcurrent and short circuit, and it is therefore it is named “no-electric-contact electric shock current leakage protection device”.

The preferred embodiment does not concurrently provide protection against overcurrent and short circuit, and it is therefore it is named “no-electric-contact electric shock current leakage protection device”.

The structural components of the preferred embodiment are as follows:

Digital logic microcontroller A, fault sensor circuit B, electromagnetic trip circuit C, low voltage supply circuit D, ground line circuit PE, a set of corresponding members F and others.

The components and their connections of the preferred embodiment are as follows:

1. Low voltage supply circuit D comprises voltage reducing capacitor C1, filter capacitor C2, diode D1, diode D2, voltage-regulator tube Dz and others; in which, one end of C1 is connected with Lc end of the phase line, and the other end of C1 is parallel connected with the anode of D1, the cathode of D2; the cathode of D1 is parallel connected with the anode of C2, the cathode of Dz to become the low-voltage power supply V+; the anode of D2 is parallel connected with the cathode of C2 and the anode of Dz to become low-voltage power supply V−; V+ is connected with a1 of digital logic microcontroller A, and V− is connected with a− of A; V− is also the shared “−” end, and it is then connected with Nc of the neutral line.

2. Leakage sensor circuit b1 in fault sensor circuit B comprises the zero-sequence current transformer T, capacitor c5 and others; in which, phase line Lc and neutral line Nb go through the middle hole of T electromagnetic winding, and winding end 1 of T is connected with input terminal a1 of the first tier circuit, T winding end 2 is connected to the shared “−” electrode, and one end of C5 is connected with T winding end 1 and the other end of C5 is connected to T winding end 2.

3. Fault sensor circuit b2 for the disconnected ground line in fault sensor circuit B comprises coupler w, capacitor C3, capacitor C4 and others; in which, one end of C3 is connected to Lc of the power supplying phase line, and the other end of C3 is first connected in series with C4, and then is connected to end 1 of w, and end 2 of w is connected with Nc of the power supplying neutral line; end 3 of w is connected to input terminal a21 of the second tier circuit and end 4 of w is connected to a22.

4. Rear driving circuit c1 comprises thyristor SCR, capacitor C6 and others; in which, the anode of SCR is connected with end 1 of c2, and the cathode of SCR is connected to the shared “−” electrode, the control gate of SCR is connected with output end a4 of the precursor circuit, one end of C6 is connected with the control gate of SCR and the other end of C6 is connected with the shared “−” electrode.

5. Electromagnetic trip device c2 includes diode D3, follow-current diode D4; in which, end 2 of c2 is connected with the cathode of D3, the anode of D3 is connected with Lc of the phase lines, end 1 of c2 is connected with the anode of SCR, the cathode of D4 is connected to end 2 of c2, and the anode of D4 is connected with end 1 of c2.

6. One end of the ground line PE is led out from the junction of C3 and C4 of sensor circuit b2 for the disconnected ground line and others, and the other end of PE is connected to the metal plate PE terminal at the bottom of the housing; when first in use, the input end of PE is fixed to the ground line PEN of the “TN−C−S” electricity supply system, or is fixed to the grounded ground line of the “T−T” electricity supply system, or fixed to the qualified ground line that is repeatedly grounded, and the output end is fixed to the metal housing or metal frame of the controlled electric equipment.

7. Leakage detecting circuit F9 comprises resistor R, leakage testing switch S and others; in which, one end of R is connected to Lc end of the phase line, and the other end of R is connected to one end of switch S, and the other end of switch S is connected to Nc of the neutral line.

8. Input terminals F21 and F22 are connected respectively with La of the phase line and Na of the neutral line; output terminals F31 and F32 are connected respectively with Lc of the phase line and Nc of the neutral line.

The operating principle of the preferred embodiment 3 is similar to that of the preferred embodiment 2, therefore it is not further described here.

Preferred Embodiment 4

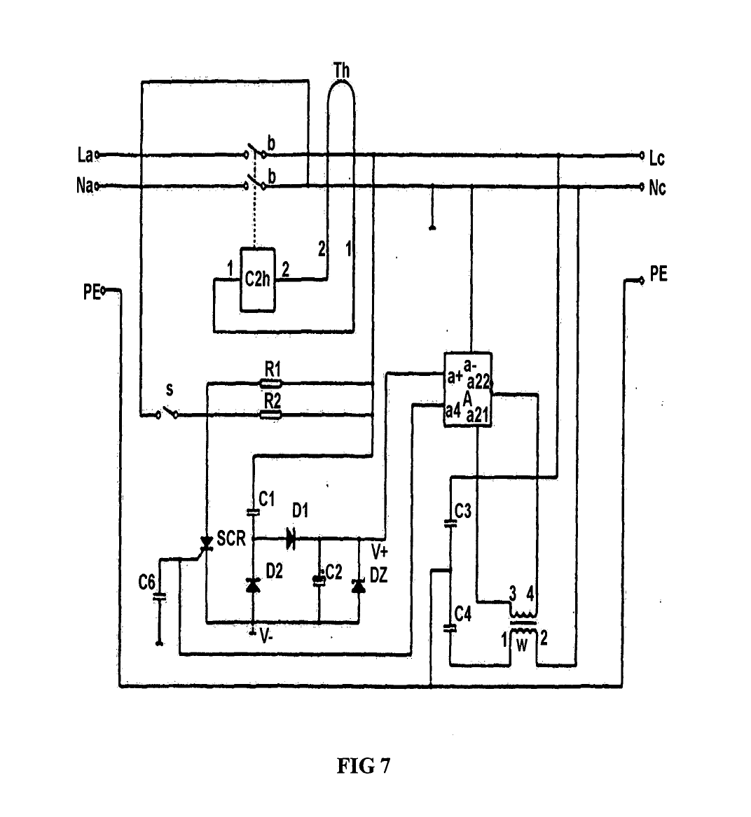

The preferred embodiment is a single-phase electromagnetic no-current-contract electric shock prevention residual current circuit breaker (three lines: L+N+PE). The electrical schematic diagram of the preferred embodiment is shown as FIG. 7.

The components and their connections of the preferred embodiment are as follows:

1. Low voltage supply circuit D comprises voltage reducing capacitor C1, filter capacitor C2, diode D1, diode D2, voltage-regulator tube Dz and others; in which, one end of C1 is connected Lc end of the phase line, the other end of C1 is parallel connected with the anode of D1 and the cathode of D2; the cathode of D1 is parallel connected with the anode of C2 and the cathode of Dz to become low-voltage power supply V+; the anode of D2 is parallel connected with the cathode of C2 and the anode of Dz to become low-voltage power supply V−, and V+ is connected with a1 of the digital logic microcontroller A, and V− is connected with a− of A; V− is also a shared “−” electrode and it is then connected with Nc of the neutral line.

2. Leakage sensor circuit b1 comprises electromagnetic zero-sequence current transformer T; in which, Lb of the phase line and Nb of the neutral line go through the middle hole of T electromagnetic winding, and end 1 of T winding is connected to end 1 of electromagnetic type electromagnetic trip device c2, and end 2 of T winding is connected with electromagnetic type electromagnetic trip device c2.

3. Sensor circuit b2 for the disconnected ground line and others comprises coupler w, capacitor C3, capacitor C4 and others; in which, one end of C3 is connected output end Lc of the phase line, the other end is connected in series with C4 first and then is connected with end 1 of w, and end 2 of w is connected with Nc of the power supply neutral line; end 3 of w is connected with input a21 of digital logic microcontroller A, and end 4 of w is connected with input a22 of w.

4. Rear driving circuit c1 comprises thyristor SCR, capacitor C6, current-limiting resistor R1 and others; in which the anode of SCR is connected in series with output Lc of R1 power supply phase line, and the cathode of SCR is connected with the share “−” electrode, the control gate of SCR is connected with output a4 of the precursor circuit, and one end of C6 is connected with the control gate of SCR and the other end of C6 is connected with the shared “−” electrode.

5. The connections of electromagnetic type electromagnetic trip device c2 is described as (2) above.

6. One end of ground line PE is let out from the junction of C3 and C4 of sensor circuit b2 for the disconnected ground line and others, and the other end of PE is connected with the metal plate PE terminal beset at the bottom of housing F10; When first in use, the input of PE is fixed to ground line PEN under the “TN−C−S” electricity supply system, or is fixed to the grounded ground line of the “T−T” electricity supply system, or is fixed to the qualified ground line that is repeatedly grounded, and the output is fixed to the metal housing or metal frame of the controlled electric equipment.

Leakage detecting circuit F9 comprise resistor R2, leakage testing switch S and others; in which, one end of R is connected to Lb of the phase line, and the other end of R2 is connected to one end of switch S, and the other end of switch S is connected with Nb of the neutral line.

Input terminals F21 and F22 are connected respectively to input La of the phase line and input Na of the neutral line; output terminals F31 and F32 are connected respectively with output Lc of the phase line and output Nc of the neutral line.8. Input terminals F21 and F22 are connected respectively to input La of the phase line and input Na of the neutral line; output terminals F31 and F32 are connected respectively with output Lc of the phase line and output Nc of the neutral line.

The operating principle of the preferred embodiment 4 is similar to that of the preferred embodiment 3. It is therefore not described here.

What we claim is:

1. An electric shock prevention residual current circuit breaker comprises:
a digital logic microcontroller, including a first tier circuit, a second tier circuit, a logic processing circuit, a precursor circuit, and a digital generating circuit;
a fault sensor circuit, including a leakage sensor circuit and a sensor circuit for detecting disconnected ground line;
an electromagnetic trip circuit, including a rear driving circuit and an electromagnetic trip device;
a low voltage supply circuit, including a voltage reducing capacitor, a filter capacitor, a rectifying tube, and a voltage-regulator tube;
a set of corresponding members, including a close or open circuit assembly, an input terminal, an output terminal, a switch handle, an overcurrent and short circuit trip device, a dynamic contact, a static contact, an avoiding arc device, a leakage detecting circuit, and a housing; and
a ground line circuit, including a metal plate at the bottom of the housing and a plurality of connecting wires.

2. The electric shock prevention residual current circuit breaker as claimed in claim 1, wherein the input of the first tier circuit in digital logic microcontroller is connected with the leakage sensor circuit, and the output of the first tier circuit is connected with the input end of the logic processing circuit; the input of the second tier circuit is connected with the sensor circuit for detecting disconnected ground line, and the output of the second tier circuit is connected with the input of the logic processing circuit, and the output of the logic processing circuit is connected with the input of the precursor circuit; the output of the precursor circuit is connected with the input of the rear driving circuit; and digital generating circuit provides digital signal source for digital logic microcontroller.

3. The electric shock prevention residual current circuit breaker as claimed in claim 2, wherein the digital logic microcontroller can be carried out either by medium scale or large scale integrated circuits or by separate electronic components; it can also be carried out by electronic circuit combinations with different sensitivities and amplifications; and it can be carried out by changing the orders of connections in accordance with the electrical schematic diagrams.

4. The electric shock prevention residual current circuit breaker as claimed in claim 1, wherein the digital logic microcontroller can be carried out either by medium scale or large scale integrated circuits or by separate electronic components; it can also be carried out by electronic circuit combinations with different sensitivities and amplifications; and it can be carried out by changing the orders of connections in accordance with the electrical schematic diagrams.

5. The electric shock prevention residual current circuit breaker as claimed in claim 1, wherein the leakage sensor circuit of the fault sensor circuit further comprises a zero-sequence current transformer and a capacitor; one end of the zero-sequence current transformer is connected with the first tier circuit, and other end of the zero-sequence current transformer is connected with the shared negative electrode; the capacitor is parallel with and connected to both ends of the zero-sequence current transformer.

6. The electric shock prevention residual current circuit breaker as claimed in claim 5, wherein the sensor circuit for detecting disconnected ground line is consisted of a plurality of capacitors and a coupler, one of the plurality of capacitors is connected to the output of the power supply phase line at one end and connected in series with other capacitor first, then connected to a first end of the coupler; a second end of the coupler is connected to the output of the power supply neutral line; a third end of the coupler is connected to a first input of the first tier circuit of the digital logic microcontroller; a fourth end of the coupler is connected to a second input of the first tier circuit of the digital logic microcontroller; a plurality of capacitors first connected in series then connected to the ground line.

7. The electric shock prevention residual current circuit breaker as claimed in claim 6, wherein a coupler adopted by the sensor circuit for the disconnected ground lines can be carried out by using an electromagnetic coupler or an optocoupler, and the plurality of capacitors can be carried out by using resistors or inductors.

8. The electric shock prevention residual current circuit breaker as claimed in claim 1, wherein a coupler adopted by the sensor circuit for the disconnected ground lines can be carried out by using an electromagnetic coupler or an optocoupler, and the plurality of capacitors can be carried out by using resistors or inductors.

9. The electric shock prevention residual current circuit breaker as claimed in claim 1, wherein the rear driving circuit further comprises:
a thyristor; the anode of the thyristor is connected with a first end of the electromagnetic trip device, and the cathode of the thyristor is connected with a shared “−” electrode; a control gate of the thyristor is connected with the output of the precursor circuit of the digital logic microcontroller; and
a capacitor; one end of the capacitor is connected with the thyristor control gate and the other end of the capacitor is connected with the shared “−” electrode.

10. The electric shock prevention residual current circuit breaker as claimed in claim 9, wherein the electromagnetic trip device further comprises:
a diode;
a follow-current diode; and
a first end of the electromagnetic trip device is connected with the cathode of the diode, and the anode of the diode is connected with the output of the power supply phase line;
the cathode of the follow-current diode is connected with the first end of the electromagnetic trip device, and the anode of the follow-current diode is connected with a second end of the electromagnetic trip device.

11. The electric shock prevention residual current circuit breaker as claimed in claim 10 further comprises:
an electronic type electromagnetic trip device, which can be carried out by an electromagnetic type electromagnetic trip device;
an electromagnetic type zero-sequence current transformer; and a first end of the electromagnetic type electromagnetic trip device is connected with a first end of the electromagnetic type zero-sequence current transformer, and a second end of the electromagnetic type electromagnetic trip device is connected with a second end of the electromagnetic type zero-sequence current transformer; the anode of the thyristor of the rear driving circuit is connected first in series with a resistor then connected with the output of the power supply phase line, the cathode of the thyristor is connected with the shared “−” electrode; the control gate of the thyristor is connected with the output of the precursor circuit of the digital logic microcontroller.

12. The electric shock prevention residual current circuit breaker as claimed in claim 1, wherein a first end of the metal plate of the ground line circuit is connected with the junctions of the plurality of capacitors connected in series of the sensor circuit for the disconnected ground line, and a second end of the metal plate is connected with the metal plate terminal at the bottom of the housing.

13. The electric shock prevention residual current circuit breaker as claimed in claim 12, when first in use the input of the metal plate is fixed to the ground line under a TN−C−S electricity supply system, or fixed to the grounded ground line under a T−T electricity supply system, or fixed to the qualified ground line that is repeatedly grounded; the output of the metal plate is fixed to the metal housing or metal frame of the controlled electric equipment.

14. The electric shock prevention residual current circuit breaker as claimed in claim 1, wherein the low voltage supply circuit further comprises:
a plurality of rectifying diodes;
a plurality of voltage-regulator diodes; and
a first end of the voltage reducing capacitor is connected with the output of the power supply phase line, and a second end of the voltage reducing capacitor is parallel connected with the anode of one of the plurality of rectifying diodes and the cathode of another rectifying diodes; the cathode of one of the plurality of rectifying diodes, the anode of the filter capacitor, and the cathode of one of the plurality of voltage-regulator diodes are parallel connected together to become the V+ electrode of the low-voltage power supply; the anode of another rectifying diodes, the cathode of the filter capacitor, and the anode of one of the plurality of voltage-regultor diodes are parallel connected together to become the V− electrode of the low-voltage power supply; and the V+ electrode is connected with the “a+” of the digital logic microcontroller, the V− electrode is connected with the “a−” of the digital logic microcontroller.

15. The electric shock prevention residual current circuit breaker as claimed in claim 14, wherein the voltage reducing capacitor of the power supply circuit can be carried out by a reducing resistor; the half-wave rectification formed by a plurality of rectifying diodes can be carried out by bridge-type full-wave rectification; and the plurality of voltage-regulating diodes can be carried out by a three-end voltage-regulator tube.

16. An electric shock prevention residual current circuit breaker comprises:
a digital logic microcontroller;
a set of corresponding members, including an overcurrent and short circuit trip device and a leakage detecting circuit; and
a plurality of circuitry, including a fault sensor circuit, an electromagnetic trip circuit, a low voltage supply circuit, and a ground line circuit, wherein the plurality of circuitry and the set of corresponding members coupled with the digital logic microcontroller provide no-current-contact electric shock protection against current leakage, overcurrent and short circuit.

17. A digital logic microcontroller for detecting electric faults comprises:
a first tier circuit;
a second tier circuit;
a logic processing circuit, wherein the input of the logic processing circuit is connected with the output of the first tier circuit and the output of the second tier circuit;
a precursor circuit, wherein the input of the precursor circuit is connected with the output of the logic processing circuit; and
a digital generating circuit for providing digital signal source.

18. The digital logic microcontroller for detecting electric faults as claimed in claim 17, wherein the input of the first tier circuit is connected with a leakage sensor circuit and the input of the second tier circuit is connected with a sensor circuit for detecting disconnected ground line.

19. The digital logic microcontroller for detecting electric faults as claimed in claim 18, wherein the output of the precursor circuit is connected with the input of a rear driving circuit, which comprises a thyristor and a capacitor.

20. The digital logic microcontroller for detecting electric faults as claimed in claim 19 can be utilized in electric shock prevention residual current circuit breakers, and in various electrical appliances and electrical supply systems against current leakage, overcurrent and short circuit.
